(19) United States
(12) Patent Application Publication
(10) Pub. No.: US 2026/0295888 A1
(43) Pub. Date: Oct. 1, 2026

(54) 3D PRINTED SAW GUIDE PADS AND MANUFACTURING METHODS

(71) Applicant: Simonds International L.L.C., Woodland, WA (US)

(72) Inventors: James Wankel, Salmon Arm (CA); Norman Brown, Woodland, WA (US)

(21) Appl. No.: 19/578,672

(22) Filed: Mar. 25, 2026

Related U.S. Application Data
(60) Provisional application No. 63/777,607, filed on Mar. 25, 2025.

(51) Int. Cl. B27B 5/29; B27B 13/10; B27B 13/12; B33Y 80/00

(52) U.S. Cl. CPC B27B 5/29; B27B 13/10; B33Y 80/00; B27B 13/12

(57) ABSTRACT

A saw blade guide pad includes a back side, a front side, an interior, an inlet passage extending from an inlet opening on the back side to the interior, an outlet passage extending from an outlet opening on the front side to the interior, and an interior passage connecting the inlet passage to the outlet passage. The saw blade guide pad is formed by additive manufacturing (e.g., by 3D printing) according to embodiments of the method disclosed herein.

### CROSS-REFERENCE TO RELATED APPLICATIONS

The present application claims the benefit of U.S. Provisional Patent Application No. 63/777,607 filed Mar. 25, 2025 and titled “3D PRINTED SAW GUIDE PADS AND MANUFACTURING METHODS”, the entire disclosure of which is hereby incorporated by reference.

### TECHNICAL FIELD

The present disclosure provides embodiments of guide pads for circular saw blades and band saw blades, and methods of manufacturing such guide pads.

### BACKGROUND

Sawmills, panel mills, and other industrial wood processing facilities use a variety of saws to cut wood into pieces to produce finished or semi-finished products such as lumber, wood veneer, and engineered wood products (e.g., plywood, laminated veneer lumber, etc.). Circular saws and band saws are two of the most common saw types.

A circular saw has a circular saw blade mounted to an arbor that extends through the center annulus (the ‘eye’) of the blade. The arbor is driven in rotation to rotate the circular saw blade for cutting operations. Gang saws are circular saws that have multiple blades mounted to one arbor; some also have a second arbor with corresponding blades. Circular saws typically offer faster cutting speeds and lower cost of ownership than band saws.

A band saw (or ‘bandsaw’) has a band saw blade trained around a pair of wheels. The band saw blade is an endless loop, usually made of steel or other metal, with teeth, abrasive material, or other sharp surfaces distributed along one of the outer edges to form a cutting edge. One of the wheels is driven in rotation to rotate the band saw blade for cutting operations. The other wheel is usually adjustable to adjust the blade angle, to increase or decrease the tension applied to the blade, and/or enable removal and replacement of the blade. As band saw blades tend to be thinner than circular saw blades, band saws can be more precise and produce a narrower kerf (i.e., the slot formed in the workpiece by the blade as it cuts) than circular saws, producing comparatively less sawdust and greater wood volume recovery from a given log.

Some prior circular saws and band saws have been provided with guide systems for reducing unwanted deviation of the saw blade(s) during cutting operations. One prior guide system for circular saws guides the circular saw blades between guide pads that are mounted to guide arms. Fluid passages extend through the guide arms and the guide pads to an opening within a recess, or fluid pocket, on the front (blade-facing) side of the guide pad. The recess is surrounded by a bearing surface. The guide arms are connected to a source of pressurized fluid (e.g., water, oil, and/or coolant). The fluid flows through the fluid passages into the fluid pocket to form a film on the corresponding side of the saw blade. In addition to cooling and lubricating the saw blade, the liquid reduces friction between the blade and the bearing surface of the guide pad. When the circular saw blade reaches an adequate rotational speed, the system reaches a hydrodynamic state in which the guide pads ride on the films of pressurized liquid to stabilize the blade against deflection while having little or no direct contact with the blade.

Prior saw guide systems for band saws used guide pads (also known as guide blocks) that were fixed in position along one or both sides of the band saw blade, typically with a small clearance between the blade and the guide pad(s), to minimize twisting or deflection of the band saw blade during cutting. One prior system has a nozzle positioned to spray cooling/lubricant oil onto the band saw blade above the guide pad. This is intended to produce a hydrodynamic state by creating an oil wedge in the narrow gap between blade and the guide pad.

Currently the most accepted practice for circular saw guide pads is to pour molten ASTM Babbitt into a mold to form the guide pad. This is dangerous, and the molten babbitt material emits fumes that are not healthy. The resulting pads can only be used in sawing operations for about 6-10 hours on average when conditions are good, and the useful life is even shorter under less optimal conditions.

### BRIEF DESCRIPTION OF THE DRAWINGS

Embodiments will be readily understood by the following detailed description in conjunction with the accompanying drawings. Embodiments are illustrated by way of example and not by way of limitation in the figures of the accompanying drawings.

FIGS. 1A and 1B illustrate a plan view and a sectional view, respectively, of a prior guide pad for a circular saw;

FIGS. 1C and 1D illustrate views of fluid flow on a prior circular saw guide pad;

FIG. 1E illustrates a prior circular saw guide system;

FIG. 1F illustrates a prior band saw guide system;

FIGS. 1G and 1H illustrate a schematic side view and a plan view, respectively, of a prior guide pad for a band saw.

FIGS. 2A and 2B illustrate a plan view and a sectional view, respectively, of a guide pad for a circular saw;

FIG. 2C is a schematic view of liquid flowing from the guide pad of FIG. 2A;

FIG. 3A is a plan view of another guide pad for a circular saw;

FIG. 3B is a schematic view of liquid flowing from the guide pad of FIG. 3A;

FIG. 4 illustrates another guide pad for a circular saw;

FIGS. 5A and 5B illustrate a plan view and a sectional view, respectively, of another guide pad for a circular saw;

FIGS. 6A and 6B illustrated a schematic side view and a front elevational view, respectively, of a guide pad for a band saw;

FIG. 7A illustrates a schematic side view of another guide pad for a band saw;

FIG. 7B illustrates a schematic view of a band saw guide system; and

FIG. 8 illustrates a schematic view of a circular saw guide system, all in accordance with various embodiments.

### DETAILED DESCRIPTION OF DISCLOSED EMBODIMENTS

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous.

The present disclosure provides embodiments of circular saw guide pads and band saw guide pads, and methods for producing such guide pads. In exemplary embodiments, a computing device may be endowed with one or more components of the disclosed apparatuses and/or systems and may be employed to perform one or more methods as disclosed herein.

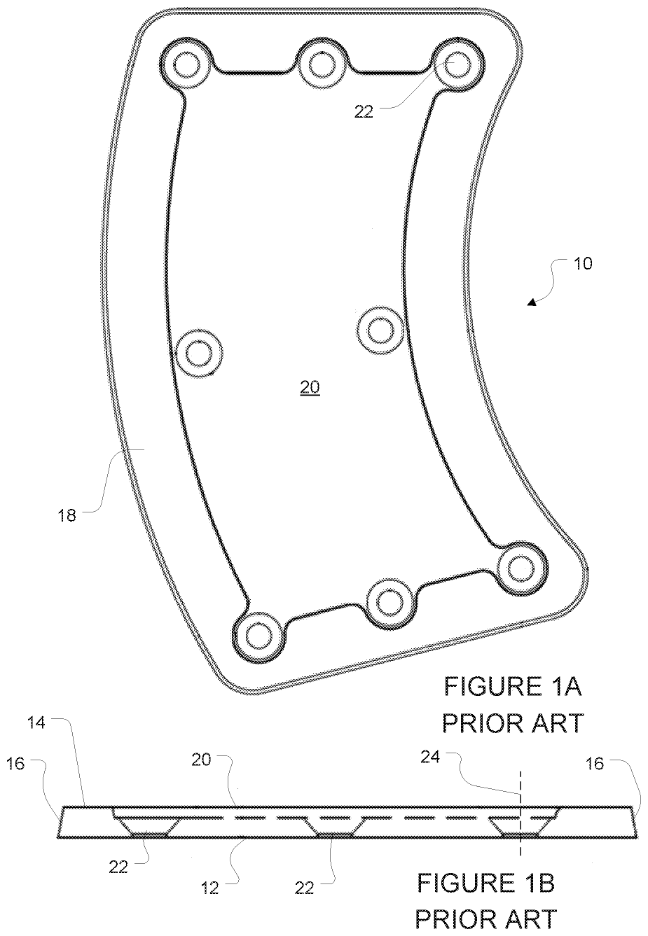

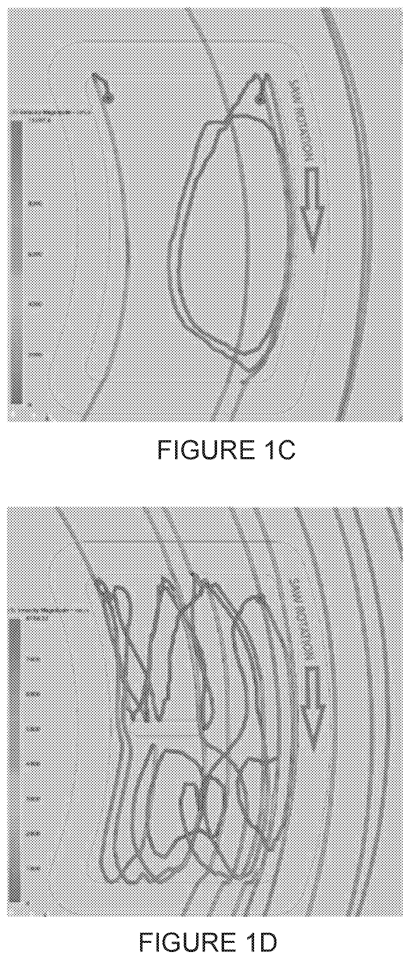

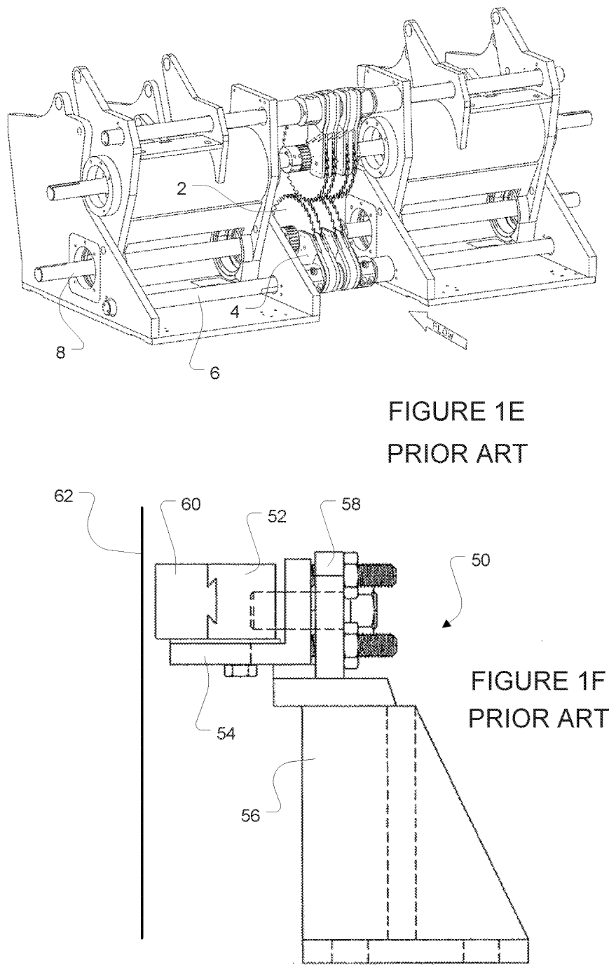

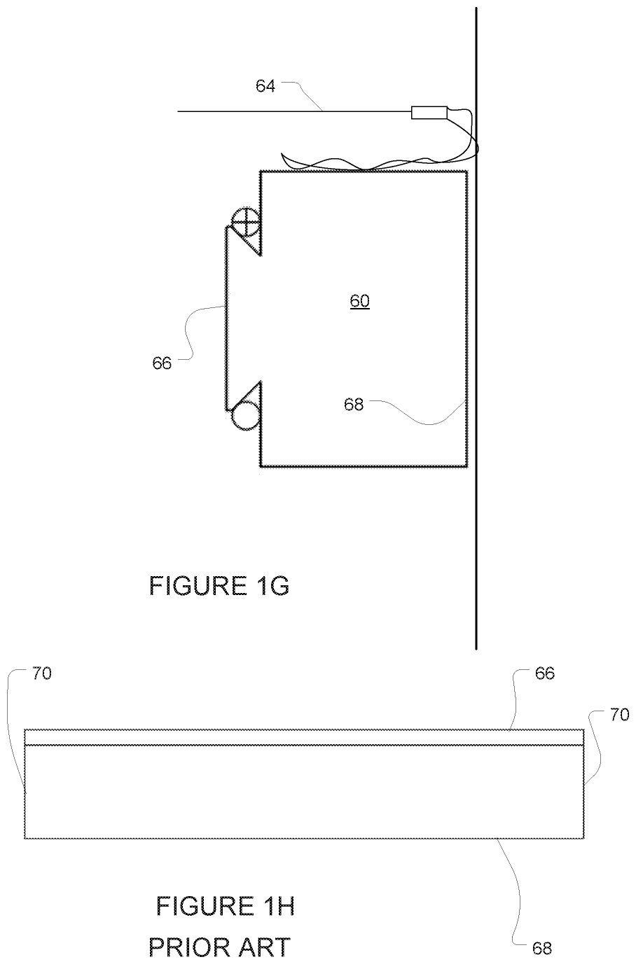

Referring first to FIGS. 1A-1E, a prior guide pad 10 for a circular saw has a back side 12, a front side 14, and lateral sides 16. The front side 14 has a bearing surface 18 that surrounds a fluid pocket 20, which is recessed relative to bearing surface 18. Through-holes 22 extend through the thickness of the guide pad from the back side 12 to the front side 14, opening into the fluid pocket 20. Each through-hole 22 has a center axis 24 that is perpendicular to the back side and the front side. The guide pad 10 is formed by pouring molten babbitt material into a mold. The bottom of the mold has a three-dimensional (3D) shape that corresponds to the shape of the front side 14 of the pad, such that the molding process forms the bearing surface 18, fluid pocket 20, and lateral sides 16. The through-holes 22 are also formed in the molding process. After the babbitt material cools and is removed from the mold, the bearing surface is machined to square the face for any imperfect guide arm conditions.

The through-holes 22 are shaped to accommodate bolts that are used to attach the guide pad to a corresponding guide arm 4 (FIG. 1E). The through-holes 22 are arranged to match the locations of bolt holes and fluid outlets along the guide arm. The bolts (not shown) have a center through-hole that is sealed with an insert or—if it is aligned with a fluid passage in the guide arm—left open for use as a fluid passage.

In operation, a pair of guide pads 10 on respective guide arms 2 are positioned on opposite sides of a circular saw blade 2 with a small gap (e.g., 0.001″ to 0.002″) between each guide pad 10 and a corresponding side of the circular saw blade. Pressurized fluid from a fluid source flows from the guide arm and through the open center through-holes in the bolts to the fluid pocket 20 and into the gap to contact the circular saw blade. The path of the fluid can be analyzed with water/fluid modeling software, as shown for example in FIGS. 1C and 1D.

A prior band saw guide system 50 and corresponding guide pad 60 are shown in FIGS. 1F-H. Band saw guide system 50 has a guide pad holder 52 supported on a mount 54, which is in turn mounted on a support 56 by an adjustment mechanism 58. The guide pad holder 52 is configured to be connected to the back of the guide pad 60 (e.g., by a dovetail joint or the like), and the adjustment mechanism is operable to move the mount 54 to adjust the distance between guide pad 60 and a band saw blade 62 (shown schematically). Band saw guide system 50 was also provided with a fluid nozzle 64 used to spray cooling/lubricating oil onto the band saw blade 62 (see FIG. 1G). Regardless, guide pad 60 has a back side 66, a front side 68, and lateral sides 70.

In operation, the front side of the guide pad 60 is positioned close to a corresponding side of the band saw blade, leaving only a small gap between the guide pad and the blade. As the band saw is rotated, pressurized oil is sprayed onto the band saw blade above the guide pad.

The prior saw guide systems described above have several disadvantages. The conventional babbitt saw guide pads of the prior circular saw guide system have a relatively short service life, requiring frequent stoppages of the production line for guide pad replacement. The molten babbitt material can release fumes that are toxic to human operators. In addition, the guide pad designs are limited to what can be poured in a mold.

In the prior band saw guide system, most of the oil that is sprayed toward the gap between the guide pad and the band saw blade does not enter the gap, but is instead wiped from the blade by the guide pad. As a result, the system is unable to reach a hydrodynamic state.

The present disclosure provides embodiments of guide pads and corresponding methods of producing such guide pads.

In various embodiments, a method for producing a saw blade guide pad includes using an additive manufacturing device to deposit at least a first material in successive layers to form a pad body with a back face, a front face, an interior, an inlet passage extending from an inlet opening on the back face to the interior, an outlet passage extending from an outlet opening on the front face to the interior, and an interior passage connecting the inlet passage to the outlet passage.

The additive manufacturing device may be a 3D printer. The additive manufacturing device may form the pad body according to a digital model (e.g., a CAD model). The first material may be a 3D printer filament. In some embodiments, the 3D printer filament is formed from a thermoplastic polymer compound (optionally with additives and/or fillers, such as fibers and/or solid lubricants). For example, the 3D printer filament may be made from a combination of base polymers, reinforcing fibers, and solid lubricants.

In various embodiments, a saw blade guide pad has a back side, a front side, an interior, an inlet passage extending from an inlet opening on the back side to the interior, an outlet passage extending from an outlet opening on the front side to the interior, and an interior passage connecting the inlet passage to the outlet passage to thereby enable a pressurized liquid introduced into the inlet opening to flow through the inlet passage, the interior passage, the outlet passage, and the outlet opening onto the front side of the guide pad. The interior passage may be in fluid communication with the exterior exclusively through the inlet and outlet passages. In some embodiments the interior passage may extend transverse to the inlet passage and/or the outlet passage. Optionally, the interior passage may be generally parallel to the front face and/or the back face.

In some embodiments, the front side may have a bearing surface and a fluid pocket that is recessed relative to the bearing surface. In that case, the outlet opening may be disposed within the fluid pocket. Alternatively, the outlet opening may be disposed along the bearing surface. In other embodiments the front side may lack a fluid pocket and the outlet opening may be disposed along the bearing surface. In either case the interior passage may optionally be disposed between the bearing surface and the back face. For example, in some embodiments, the bearing surface may extend around an outer periphery of the front face, the outlet opening may be located along the bearing surface, and the interior passage may form a loop that is below, and in alignment with, the bearing surface.

In some embodiments, a guide pad may have one or more internal voids. The internal voids may be in fluid communication with the interior passage. This may allow the guide pad to receive more fluid, which may in turn help to cool the guide pad and/or the saw blade. Alternatively, or in addition, a guide pad may have one or more internal voids that are closed (i.e., are not in fluid communication with the interior passage). This may reduce the amount of material required to form the guide pad.

In some embodiments, a guide pad may have one or more surface channels along the bearing surface. A surface channel may at least partially surround one or more outlet openings.

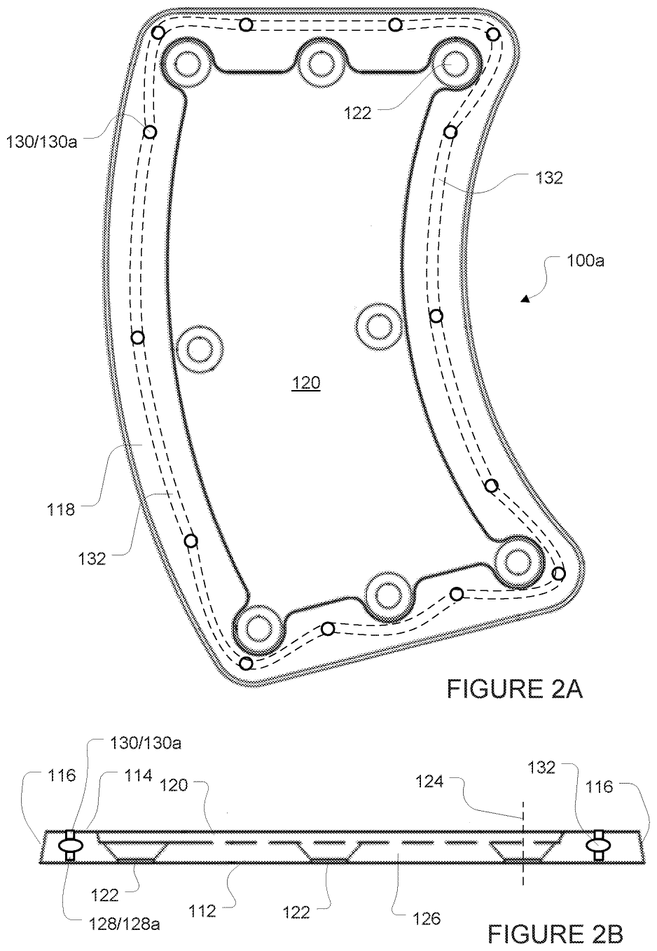

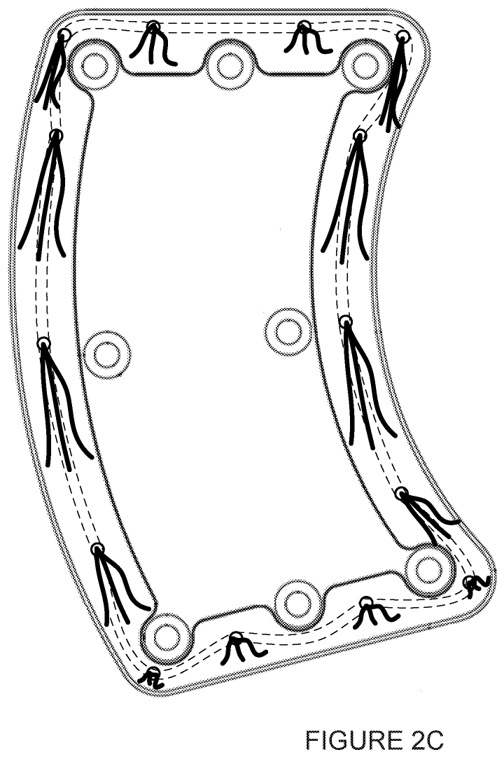

Embodiments of a guide pad for a circular saw are illustrated in FIGS. 2A-5B.

Referring now to FIGS. 2A-C, guide pad 100a has a back side 112, a front side 114, lateral sides 116, and an interior 126. The front side 114 has a bearing surface 118 that surrounds a fluid pocket 120, which is recessed relative to bearing surface 118. An inlet passage 128 extends from an inlet opening 128a on the back side 112 to the interior 126, and an outlet passage 130 extends from an outlet opening 130a on the front side 114 to the interior 126. The number and arrangement of inlet passages and outlet passages varies among embodiments, and other embodiments have only one inlet passage and/or one outlet passage. Regardless, an interior passage 130 connects the inlet passage(s) 128 to the outlet passage(s) 130. Again, while one interior passage is shown, other embodiments may have multiple interior passages, each connecting at least one inlet passage to at least one outlet passage.

Optionally, guide pad 100a may have through-holes 122 that extend through the thickness of the guide pad from the back side 112 to the front side 114. If present, through-holes 122 may open into the fluid pocket 20 and/or onto the bearing surface 118. Each through-hole 122 has a center axis 124 that is transverse to the back side 112. Through-holes 122 may be configured to receive bolts for mounting the guide pad 100a to a guide arm as described above in reference to the prior circular saw guide system. Other embodiments may lack through-holes 122. For example, guide pads lacking through-holes 122 may be provided to end users to enable the end users to form the through-holes (e.g., by drilling/machining) in locations chosen by the end users.

In this embodiment, interior passage 132 extends through the interior of the guide pad between the bearing surface 118 and the back surface 112, forming a loop. The interior passage 132 is transverse to the outlet passages 130, which open onto the bearing surface 118.

In operation, when the saw guide 110a is mounted to a guide arm, pressurized liquid flowing through the guide arm enters inlet opening 128a to flow through the inlet passage 128, the interior passage 132, the outlet passage 130, and the outlet opening 130a onto the bearing surface 118 of the guide pad (see e.g. FIG. 2C).

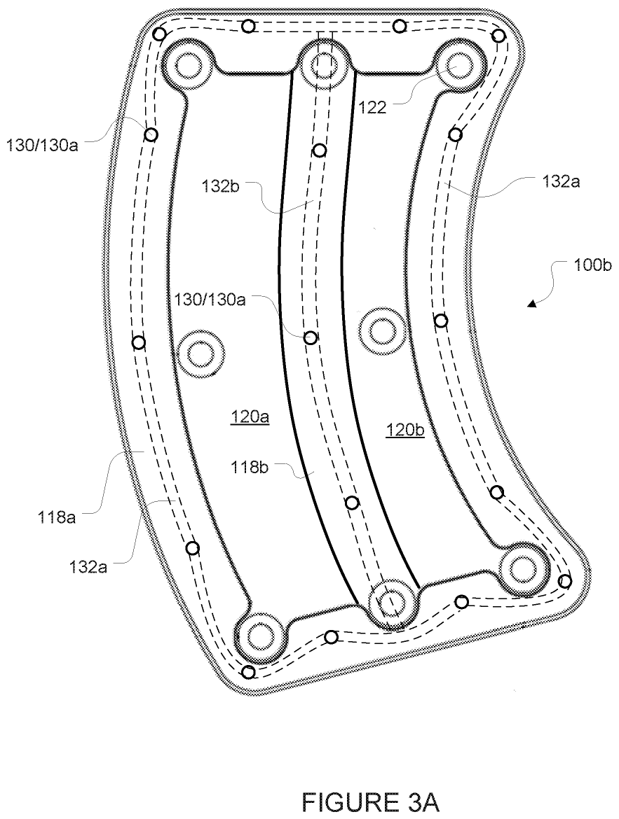

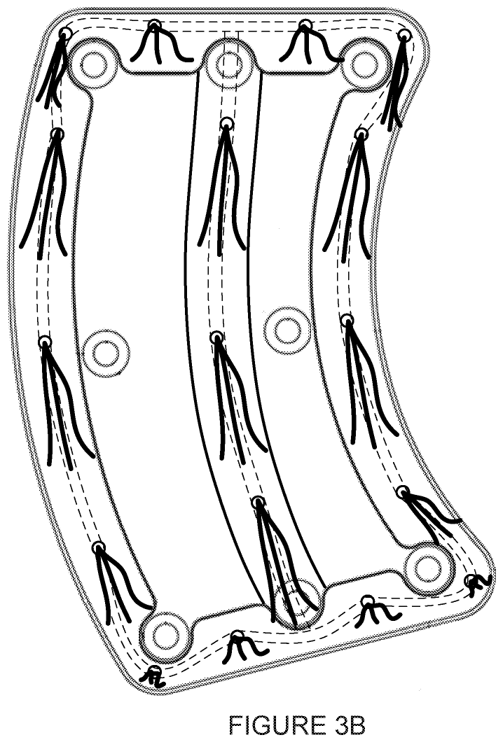

Some saw guides may have multiple bearing surfaces along the front side of the guide pad and/or multiple interior passages. For example, referring to FIGS. 3A-B, another embodiment of a guide pad 100b has a bearing surface 118a that extends around the periphery of the front side, and a second bearing surface 118b that divides the fluid pocket into two fluid pockets 120a and 120b. One interior passage 132a extends through the interior of the guide pad between the bearing surface 118a and the back side of the guide pad, and another interior passage 132b extends through the interior of the guide pad between the second bearing surface 118b and the back side of the guide pad. In this embodiment, additional outlet passages 130 extend from the second interior passage 132b to outlet openings 130a along the second bearing surface 118b. The second interior passage 132b may be connected at one or both of its opposite ends to interior passage 132a. Alternatively, second interior passage 132b may instead be connected to another fluid passage, such as a fluid passage (e.g., a through-hole) of a bolt placed in a corresponding one of the through-holes 122.

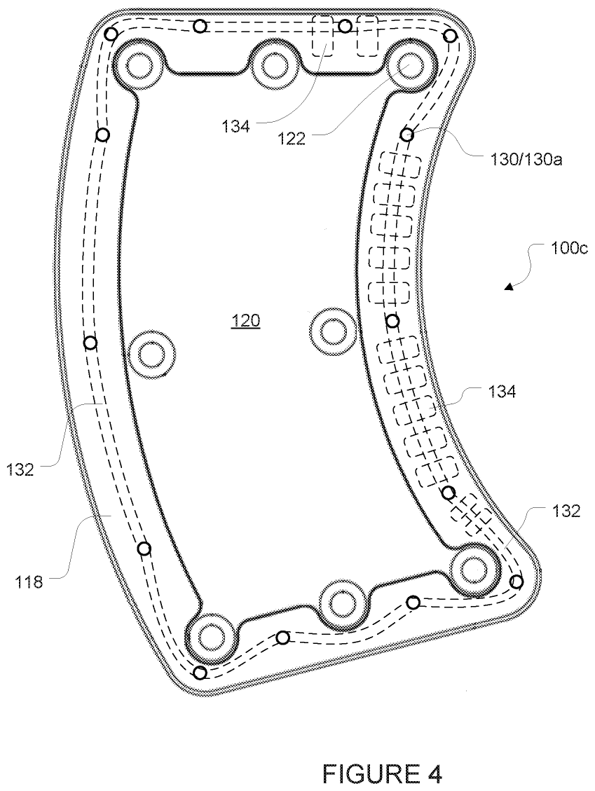

In some embodiments, a guide pad may also have one or more interior voids in fluid connection with the interior passage. For example, FIG. 4 illustrates an embodiment of a guide pad 100c with interior voids 134 distributed along at least a portion of interior passage 132. (Other labeled features/components may be the same as, or similar to, those designated with like numerals in FIGS. 2A-B.) The interior voids 134 are in fluid communication with interior passage 132. The interior voids accommodate additional fluid (e.g., water, oil, and/or coolant/lubricant). Accommodating additional fluid within the guide pad may help to cool the guide pad, thereby helping to cool the saw blade. If present, the interior void(s) may have any suitable size, shape, and location. Preferably the interior void(s)-if present-are located in the interior of the guide pad along the leading side/end of the pad.

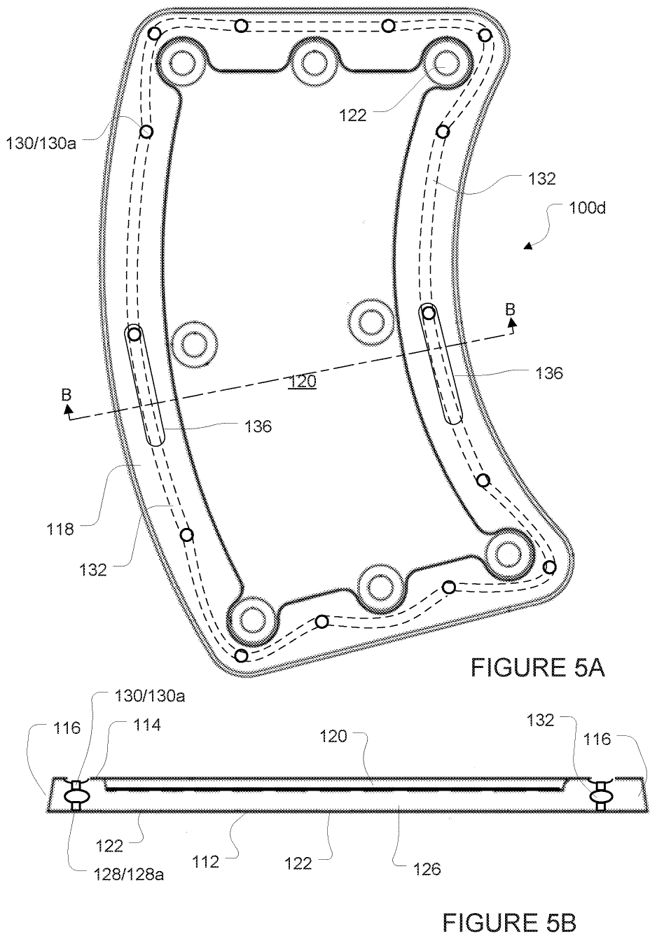

Some guide pads may have one or more surface channels along the bearing surface. One such embodiment is shown by way of example in FIGS. 5A-B. In this example, guide pad 100d has surface channels 136 formed along the bearing surface 118 and recessed relative thereto. (Again, other labeled features/components may be the same as, or similar to, those designated with like numerals in FIGS. 2A-B.) Optionally, a surface channel 136 may be positioned over an outlet opening 130a, such that the outlet opening 130a opens into the surface channel 136. Surface channels 136 may help to direct fluid flow along the bearing surface and/or help to retain additional fluid within the gap between the bearing surface and the side of the circular saw blade. If present, surface channel(s) 136 may have any suitable shape, depth, and location.

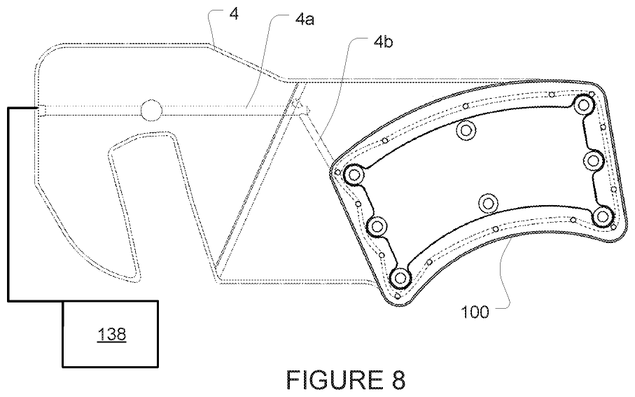

Referring briefly to FIG. 8, a circular saw guide system may include a guide arm 4 and a guide pad 100 (e.g., guide pad 100a/100b/100c/100d) mounted to the guide arm 4 (e.g., by bolts or other means). The guide arm 4 has a fluid passage with a first portion 4a that is configured to be connected to a source of pressurized fluid 138. One or more of the inlet openings along the back side of guide pad 100 are in fluid communication with the first portion 4a, or a second portion 4b, of the fluid passage of guide arm 4.

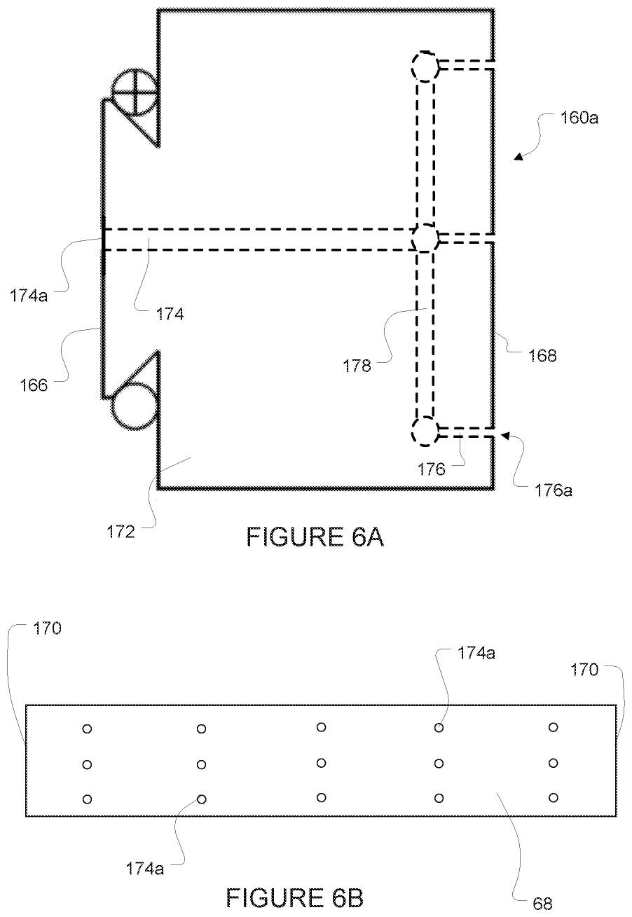

An embodiment of a guide pad 160 for a band saw is shown by way of example in FIGS. 6A-B.

In the illustrated embodiment, guide pad 160 has a back side 166, a front side 168, lateral sides 170, and an interior 172. An inlet passage 174 extends into the interior 172 from an inlet opening 174a on the back side 168. An outlet passage 176 extends into the interior 172 from an outlet opening 176a on the front side 168. An interior passage 178 connects the inlet passage 174 to the outlet passage 176. This enables a pressurized liquid introduced into the inlet opening 174a to flow through the inlet passage 174, the interior passage 178, the outlet passage 176, and the outlet opening 176a onto the front side 168 of the guide pad. While the back side of guide pad 160 is illustrated with a ‘dove tail’ configuration (i.e., configured to fit a dove tail guide pad holder), the back side or other portion(s) of the guide pad may be configured to fit any type of guide pad holder or band saw guide system.

In this embodiment, the front side 168 is a bearing surface and does not have a fluid pocket. However, in other embodiments the front side 168 may have a fluid pocket and/or one or more surface channels. For example, the front side 168 may be provided with surface channels that extend laterally and surround one or more outlet openings 176a (e.g., each surface channel may surround a lateral row of outlet openings 176a).

The interior passage may be in fluid communication with the exterior exclusively through the inlet and outlet passages. The interior passage may extend transverse to the inlet passage and/or the outlet passage. Optionally, the interior passage may be generally parallel to the front face and/or the back face.

In some embodiments, the front side may have a bearing surface and a fluid pocket that is recessed relative to the bearing surface. In that case, the outlet opening may be disposed within the fluid pocket. Alternatively, the outlet opening may be disposed along the bearing surface. In other embodiments the front side may lack a fluid pocket and the outlet opening may be disposed along the bearing surface. In either case the interior passage may optionally be disposed between the bearing surface and the back face. For example, in some embodiments, the bearing surface may extend around an outer periphery of the front face, the outlet opening may be located along the bearing surface, and the interior passage may form a loop that is below, and in alignment with, the bearing surface.

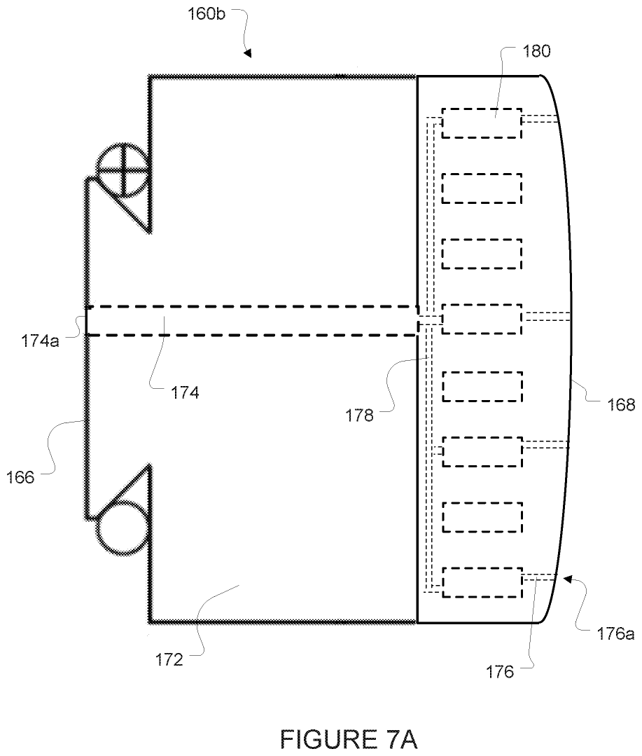

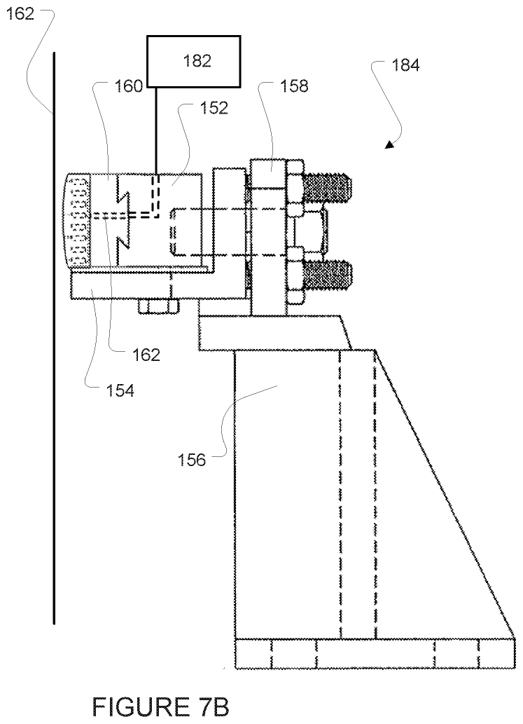

In some embodiments, a guide pad may also have one or more interior voids in fluid connection with the interior passage. For example, FIG. 7A illustrates an embodiment of a guide pad 160b with interior voids 180 distributed along at least a portion of interior passage 132. (Other labeled features/components may be the same as, or similar to, those designated with like numerals in FIGS. 6A-B.) The interior voids 180 are in fluid communication with interior passage 178. The interior voids 180 may accommodate additional fluid (e.g., water, oil, and/or coolant/lubricant), which may help to cool the guide pad and/or the saw blade, and/or may reduce the amount of material required to form the pad. If present, the interior void(s) may have any suitable size, shape, and location.

In some embodiments, the guide pad may be formed to attach to a particular type of holder. In other embodiments, the guide pad may be formed to attach to an intermediate component that is configured to attach to a particular type of holder.

Referring now to FIG. 7B, a band saw guide system includes a guide support 184 and a guide pad 160 (e.g., 160a, 160b) mounted to the guide support 184. A fluid passage 186 is configured to be connected to a source of pressurized fluid 182. The inlet opening along the back side of the guide pad is in fluid communication with the fluid passage 186. While FIG. 7B illustrates fluid passage 186 extending through a pad holder 152, in other embodiments the fluid passage may be a separate component that connects directly to an inlet passage along the lateral side (or top or bottom side) of the guide pad.

In the illustrated embodiment, the guide support 184 includes a guide pad holder 152 supported on a mount 154, which is in turn mounted on a support 156 by an adjustment mechanism 158. The guide pad holder 152 is configured to be connected to the back of the guide pad 160 (e.g., by a dovetail joint or the like), and the adjustment mechanism is operable to move the mount 154 to adjust the distance between guide pad 160 and a band saw blade 162 (shown schematically). However, guide support 184 may have any configuration suitable for supporting a guide pad in a desired location relative to a band saw blade.

In operation, the front side of the guide pad 160 is positioned close to a corresponding side of the band saw blade, leaving only a small gap between the guide pad and the blade. As the band saw is rotated, pressurized fluid (e.g., oil) supplied to the inlet opening of the guide pad moves through the inlet passage, the interior passage, the outlet passage(s), and the outlet opening(s) into the gap between the band saw blade and the guide pad.

In various embodiments, a method for producing a saw blade guide pad includes using an additive manufacturing device to deposit at least a first material in successive layers to form a pad body with a back face, a front face, an interior, an inlet passage extending from an inlet opening on the back face to the interior, an outlet passage extending from an outlet opening on the front face to the interior, and an interior passage connecting the inlet passage to the outlet passage.

The additive manufacturing device may be a 3D printer. The additive manufacturing device may form the pad body according to a digital model (e.g., a CAD model). The first material may be a 3D printer filament. In some embodiments, the 3D printer filament is formed from a thermoplastic polymer compound (optionally with additives and/or fillers, such as fibers and/or solid lubricants). For example, the 3D printer filament may be made from a combination of base polymers, reinforcing fibers, and solid lubricants.

In some embodiments, the 3D printer filament may be made from a polymer in any one or more of the following families: polyaryletherketone (PAEK), polyphenylene sulfide, polyetherimide, polyphenylsulfone, polysulfone, iglidur tribologically-optimized polymer, polycarbonate, polyamide, acrylonitrile butadiene styrene (ABS), polyethylene terephthalate glycol-modified (PETG), polylactic acid (PLA), and/or graphite-impregnated phenolic laminate.

By way of example, the printer filament may be, or may include, one or more of the following: polyether ether ketone (PEEK), polyether ketone ketone (PEKK), polyphenylene sulfide (PPS), polyetherimide (PEI) (e.g., PEI Ultem 1010 or PEI Ultem 9085), polyphenylsulfone (e.g., Radel PPSU), igus iglidur J260-PF (tribo filament), acrylonitrile butadiene styrene (ABS), thermoplastic polyurethane (TPU), thermoplastic copolyester (TPC), polylactic acid (PLA), high impact polystyrene (HIPS), polyethylene terephthalate glycol-modified (PETG), polylactic acid (PLA), polyethylene terephthalate (PET), nylon (also known as polyamide or PA; e.g., nylon 12 (PA12)), carbon fiber, acrylonitrile styrene acrylate (ASA), polycarbonate (PC), polypropylene (PP), polyphenylene sulfide (PPS), polyvinyl alcohol (PVA), carbon fiber filled filaments, metal filled filaments, and/or wood filled filaments.

Optionally, the printer filament may be a commercially available printer filament. Examples of such products include, but are not limited to, iglide® J260-PF printer filament and iglide® I190-PF printer filament, ThermaX filaments (e.g., ThermaX PEEK, PEKK-A, PPS, PEI (made using ULTEM 1010 PEI or ULTEM 9085 PEI), PPSF or PPSU).

Embodiments of this method may be used to form guide pads with any or all of the features (e.g., inlet passage, internal channel, outlet passage, internal void, surface channel, etc.) discussed herein.

Moreover, using 3D printing technology in combination with newly available printable materials and fluid design/modeling technology (e.g., modeling software) may facilitate faster design and testing of guide pads that are more finely tuned for a given saw guiding system/application. The ability to print fluid passages of any number and type within a pad body may facilitate the development of guide pads that better stabilize saw blades, and/or require less fluid during operation, than prior guide pads.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways. This application is intended to cover any adaptations or variations of the embodiments discussed herein. Therefore, it is manifestly intended that embodiments be limited only by the claims and the equivalents thereof.

What is claimed is:

1. A method for producing a saw blade guide pad, the method comprising:
using an additive manufacturing device to deposit at least a first material in successive layers to form a pad body with a back side, a front side, an interior, an inlet passage extending from an inlet opening on the back side to the interior, an outlet passage extending from an outlet opening on the front side to the interior, and an interior passage connecting the inlet passage to the outlet passage.

2. The method of claim 1, wherein the additive manufacturing device is a 3D printer.

3. The method of claim 2, wherein the first material is a 3D printer filament.

4. The method of claim 3, wherein the 3D printer filament comprises a thermoplastic polymer compound.

5. The method of claim 4, wherein the 3D printer filament comprises base polymers, fibers, and a solid lubricant.

6. The method of any claim 1, wherein the additive manufacturing device forms the pad body according to a digital model.

7. The method of claim 1, wherein the interior passage of the pad body extends transverse to the inlet passage and/or the outlet passage, or generally parallel to the front side and/or the back side.

8. The method of claim 1, wherein the front side has a bearing surface.

9. The method of claim 8, wherein the front side has a fluid pocket that is recessed relative to the bearing surface.

10. The method of claim 8, wherein the outlet opening is disposed along the bearing surface.

11. The method of claim 9, wherein the outlet opening is disposed within the fluid pocket.

12. The method of claim 8, wherein the interior passage is disposed between the bearing surface and the back surface.

13. The method of claim 12, wherein the interior passage forms a loop that is below, and in alignment with, the bearing surface.

14. The method of claim 1, wherein the pad body includes one or more voids within the interior.

15. The method of claim 14, wherein at least one of the one or more voids is in fluid communication with the internal passage.

16. The method of claim 14, wherein at least one of the one or more voids is sealed.

17. A saw blade guide pad comprising:
a back side;
a front side;
an interior;
an inlet passage extending from an inlet opening on the back side to the interior;
an outlet passage extending from an outlet opening on the front side to the interior; and
an interior passage connecting the inlet passage to the outlet passage.

18. The guide pad of claim 17, wherein the 3D printer filament comprises a thermoplastic polymer compound.

19. The guide pad of claim 18, wherein the 3D printer filament comprises base polymers, fibers, and a solid lubricant.

20. The guide pad of claim 17, wherein the additive manufacturing device forms the pad body according to a digital model.

21. The guide pad of claim 17, wherein the interior passage of the pad body extends transverse to the inlet passage and/or the outlet passage, or generally parallel to the front side and/or the back side.

22. The guide pad of claim 17, wherein the front side has a bearing surface and the outlet opening is disposed along the bearing surface.

23. The guide pad of claim 17, wherein the front side has a bearing surface and a fluid pocket that is recessed relative to the bearing surface.

24. The guide pad of claim 23, wherein the outlet opening is disposed within the fluid pocket.

25. The guide pad of claim 24, wherein the outlet opening is disposed along the bearing surface.

26. The guide pad of claim 22, wherein the interior passage is disposed between the bearing surface and the back surface.

27. The guide pad of claim 26, wherein the interior passage forms a loop that is below, and in alignment with, the bearing surface.

28. A saw guide system comprising the guide pad of claim 17.
